(19) United States
(12) Patent Application Publication
(10) Pub. No.: US 2021/0046341 A1
(43) Pub. Date: Feb. 18, 2021

(54) PROCESS FOR RECYCLING COMPONENTS OF A CONFINED SPACE METAL CONTAINER

(71) Applicant: Vertex Energy, Houston, TX (US)

(72) Inventors: Timothy Sims, Houston, TX (US); Benjamin Cowart, Houston, TX (US)

(21) Appl. No.: 16/992,528

(22) Filed: Aug. 13, 2020

Related U.S. Application Data
(60) Provisional application No. 62/887,336, filed on Aug. 15, 2019.

(51) Int. Cl. A62C 3/06; B63B 85/00; B62D 65/00; A62C 2/04

(52) U.S. Cl. CPC A62C 3/065; B63B 85/00; B61D 5/00; A62C 2/04; B62D 65/00

(57) ABSTRACT

A safety process for recycling components of a confined space metal container reducing sparking, significantly mitigating worker exposure to fires by forming a first safety water blanket in first compartment, cutting a first top off, cutting off a first side, and a second side if needed. Next, pumping the first safety water blanket into a second compartment of the confined space metal container then cutting first piping out of the first compartment, and removing to a second containment area. Excavating equipment is used to remove portions of hydrocarbons from the first compartment and loading the hydrocarbons for transport; then cutting a bottom off the first compartment, and lifting the bottom onto the second containment area and cutting the bottom into preset mill sizes for recycling. Repeating the steps for additional components.

### CROSS-REFERENCE TO RELATED APPLICATIONS

The present application claims the benefit of the filing date of the U.S. Provisional Patent Application 62/887,336, entitled “PROCESS FOR RECYCLING COMPONENTS OF A CONFINED SPACE METAL CONTAINER,” filed on 15 Aug. 2019, the contents of which are hereby expressly incorporated by reference in its entirety, under 35 U.S.C. § 119(e).

### FIELD

The present embodiment generally relates to a process for recycling barges and confined space metal containers containing heavy hydrocarbon and a heavy hydrocarbon with potentially entrained lighter hydrocarbons.

### BACKGROUND

A need exists for a process to recycle barges and transport vehicles that have carried hazardous material.

A further need exists for a process to disassemble hazardous metal containers that is safer for workers.

The present embodiments meet these needs.

### BRIEF DESCRIPTION OF THE DRAWINGS

The detailed description will be better understood in conjunction with the accompanying drawings as follows:

FIG. 1 depicts a front view of a confined space metal container represented as a barge showing a plurality of compartments.

FIG. 2 depicts a front view of a confined space metal container represented as a barge showing a plurality of compartments with a crane.

FIG. 3 depicts a front view of a confined space metal container represented as a barge showing a plurality of compartments with a second containment area.

FIG. 4 depicts a detail of a location of an excavator external to a barge removing hydrocarbons from inside the barge.

FIG. 5 depicts a second compartment of a barge according to some embodiments.

FIGS. 6A,6B depict diagrams of an exemplary sequence of steps of a process of removing hydrocarbons from a metal container.

The present embodiments are detailed below with reference to the listed Figures.

### DETAILED DESCRIPTION OF THE EMBODIMENTS

Before explaining the present process in detail, it is to be understood that the process is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present disclosure.

The process stops death by reducing worker exposure to hazardous environment during confined space entry work.

The process reduces environmental damage by conducting cutting activities within a containment area reduces potential for spills into the ground and to waterways.

The process reduces the chance of human harm with the use of a water blanket which eliminates the potential of sources of ignition while cutting

The process encourages recycling of metal containers.

The process eliminates risk of stagnant “dirty” vessels creating environmental spillage. Currently barges may lay idle for long periods awaiting scrapping. This process accelerates removal of metal containers and thus reduces harm that may result from storms such as barges breaking free of their moorings.

The disclosure relates to a safety process for recycling components of a confined space metal container for cleaning and removing hydrocarbons during recycling by reducing sparking, significantly mitigating worker exposure to a heavy hydrocarbon and a heavy hydrocarbon with potentially entrained lighter hydrocarbons and fires.

The process involves positioning a first compartment of a confined space metal container for transporting hydrocarbons into a first containment processing area to prevent environmental spillage.

The process involves forming a first safety water blanket over a bottom of the first compartment of the confined space metal container over a heavy hydrocarbon and/or a heavy hydrocarbon with potentially entrained lighter hydrocarbons in the first compartment preventing sparks in the first compartment in the presence of fire or torches.

The first safety water blanket can be at a temperature from 30 to 97 degrees Fahrenheit and has a thickness ranging from 3 inches to 24 inches.

The process involves cutting a first top off the first compartment having the first water blanket, lifting the first top from the first containment area onto a second containment area and then cutting the first top into preset mill sizes while simultaneously mitigating worker exposure to fires in the first compartment.

The process involves cutting a first side from the first compartment, lifting the first side from the first containment area to the second containment area, and cutting the first side into preset mill sizes.

The process involves pumping the first safety water blanket into a second compartment of the confined space metal container forming a second safety water blanket over a bottom of the second compartment.

The process involves cutting first piping out of the first compartment after the first water blanket is pumped out, lifting the first piping from the first containment area to the second containment area, and cutting the first piping into preset mill sizes; then removing hydrocarbons from each top, side, and piping reducing flashing at a mill significantly mitigating exposure to fires; and positioning moveable removeable excavating equipment proximate to the first compartment and using the excavating equipment to remove portions of hydrocarbons from the first compartment while remaining outside the first compartment and loading the hydrocarbons for transport.

The process continues with the step of cutting a bottom off the first compartment, and lifting the bottom onto the second containment area and cutting the bottom into preset mill sizes; then if needed, moving a second compartment of the confined space metal container into the first containment processing area to prevent environmental spillage and repeating the above steps until the confined space metal container is completely recycled, preventing environmental spillage into a waterway or into ground.

In embodiments, the confined space metal containing can be made from steel, iron, and non-ferrous metals.

In embodiments, the confined space metal containing can be a barge, a truck, and in-ground tank, or a rail car.

In embodiments, the safety water blanket is formed sequentially in compartments, one at a time.

In embodiments, the hydrocarbons can be in the form of hard bottoms, a sludge, a slurry, or a liquid.

In embodiments, the cutting of the confined space metal container is with a torch, mechanical saws, shears, plasma cutters or lasers.

In embodiments, hydrocarbons can be removed from each cut side, top and/or piping can be by shaking, pressure washing, scraping, or chemical treating.

In embodiments, the process can include the step of inserting a front-end loader into the confined space metal container once at least one side is cut to facilitate removal of hydrocarbons.

In embodiments, the process can include the step of manually removing any remaining hydrocarbons from the bottom of the metal container.

In embodiments, the pumping of the safety water blanket is performed in a loop enabling reuse of the safety water blanket for each compartment of the confined space metal container, which can be a barge in some embodiments.

### Example

The safety process for recycling components of a confined space metal container for cleaning and removing hydrocarbons during scrapping by reducing sparking, significantly mitigating exposure to a heavy hydrocarbon and/or a heavy hydrocarbon with potentially entrained lighter hydrocarbons and fires as described in the following steps.

Step 1 involves positioning a first compartment, such as a 100-foot×54 foot compartment of a confined space metal container, such as a buoyant barge that has a length over all of 297 feet and a beam of 54 feet that is used for transporting hydrocarbons. In this example, the hydrocarbons can be vacuum gas oil. The barge transports the vacuum gas oil in a confined space with little ventilation. In this first step, the barge known as “TTT 310” is floated partially onto a containment processing area, such as a ramp leading into the Intercoastal Waterway in Belle Chasse, La. The ramp can be any containable surface capable of supporting significant weight, such as 30 tons. The barge TTT 310 can be floated from a mooring in the Intercoastal Waterway, and pulled using a dead man winch partially onto the ramp so that only the first compartment of the barge TTT 310 is out of the water on the ramp. The ramp assists in preventing (i) environmental spillage of metal cut from the barge TTT 310 into the waterway and preventing (ii) environmental spillage of the hydrocarbons being removed from TTT 310 into the waterway.

Step 2 involves forming a first safety water blanket in a first compartment of the barge known as TTT 310. The water can be pumped in from the Intercoastal waterway using a 10 hp water pump. The first compartment of the barge may also contains natural gas entrained in the heavy hydrocarbons which can be separated from the heavy hydrocarbon at the bottom of the barge as the first water blanket is created in the first compartment of TTT 310 barge.

The first water blanket is formed using water at normal temperatures for a July day in Belle Chasse, such as at 87 degrees Fahrenheit. The first water blanket is pumped into until there water blanket is 1 foot in thickness covering the entire base of the first compartment. The first water blanket increases humidity and reduces the chance of sparks in the first compartment when cutting tools are operating on portions of the first compartment, which for TTT 310.

Step 3 involves cutting a top off the first compartment of barge TTT 310 containing the first safety water blanket. The top is cut off with a propane cutting torch forming a cut top. The cut top for this first compartment of the barge TTT 310 is 90 feet×54 feet in size.

In this Step 3, the cut top is lifted using a crane onto a second containment area adjacent the ramp, which is known as “the containment processing area.”

This second containment area for this Example, is a cutting field adjacent the Intercoastal waterway. In the cutting field, the second containment area, the cut top is further cut into smaller pieces using propane torches. The smaller pieces match precisely preset steel mill specifications from a steel which plans to accept the components, melt the metal and recycle the barge into further useful metal. The process significantly mitigates exposure by workers to fire in the first compartment of the barge TTT 310.

Step 4 of this example, involves cutting a first side of the first compartment away from the hull. In this example, the first side forms a cut side with a dimension of 12 feet by 90 feet section. This cut side is formed by cutting the hull of the TTT 310 barge using a cutting torch while the barge is in the first containment processing area.

The first cut side is lifted with a crane off the first containment processing area onto the second containment area. In the second containment processing area, the first cut side is further cut into preset sizes determined by the steel mill accepting the cut pieces.

Step 5 involves pumping the first safety water blanket out of the first compartment. The pumping is achieved in this Example, using a submersible 2-inch positive displacement pump and flowing the water from the first compartment into a second compartment of barge TTT 310.

The second water blanket can be formed in a second compartment of the barge TTT 310, such as a compartment having a size 80 feet×50 feet. For other embodiments, the second compartment can be the same size as the first compartment.

In this example the same water from the first compartment is used to form the second safety water blanket in the second compartment. In other embodiments water can be pumped into two or more compartments simultaneously.

In yet other embodiments, the second safety water blanket can use different water than the first compartment.

Step 6 involves cutting the first piping out of the first compartment. The first piping can be mounted to the bottom of the first compartment, adjacent the keel, and the piping can be tubing such as metal heating coils. The cutting of the first piping can be performed with mechanical saws such as shears.

The cut first piping is lifted with an excavator from the first containment area and relocated to the second containment area. The first cut piping is then further cut into preset mill sizes according to steel mill specifications that will accept the cut piping for recycling. The cut piping is further cut in the second containment area with cutting torches and/or shears.

Step 7 involves removing hydrocarbons from each cut top, cut side and cut piping reducing flashing at a mill. In this example the hydrocarbons are removed in the second containment area by scraping off the hydrocarbons from the metal.

Step 8 involves positioning moveable removeable excavating equipment, such as a front-loading excavator to a location proximate to the first compartment. In this example, the front-loading excavator is located to within 2 feet of the first compartment.

In this Step 8, the front-loading excavator uses a bucket of the excavator to scrape and remove from 20 to 200 yards of petroleum solids from the bottom of the hull. It may be wet from the first water blanket. The removed material is then flowed to a tank or another barge or even a truck for further separation, drying and treatment into usable fuel.

The removed petroleum solids from the first compartment are removed in this Example, while the front-loading excavator remains outside the first compartment. The petroleum solids are inserted into roll on roll off boxes for transport and further treatment. In some embodiments, the roll on roll off boxes look like an 18 foot construction dumpster.

Step 9 involves cutting the entire bottom of the first compartment from the barge TTT 310. The bottom of the first compartment of the TTT 310 barge can be cut away using 6 propane torches.

In this Step 9, the cutting of the bottom forms a first cut bottom. The first cut bottom is then lifted from the first containment area onto the second containment area using a Komatsu 330 excavator.

In this Example, the second containment area is used to cut the first cut bottom into preset mill sizes from the steel mill that is accepting the barge metal to be recycled and reformed. The cutting of the first cut bottom into the preset sizes is achieved using torches or shears or both.

Step 10 is needed in this Example, as the barge TTT 310 has 10 different compartments, and the entire barge must be cut up for full recycling.

When the barge has more than one compartment, the barge is moved so that the next compartment, in this step, a second compartment, is positioned on the first containment processing area.

In this Example, the barge TTT 310 is dragged a small amount into the containment processing area, more precisely, another 90 feet using a containment winch to prevent environmental spillage and then steps 1 to 9 described above are repeated.

Step 1-10 are repeated until the barge TTT 310 is completely recycled into preset mill sizes according to steel mill specifications while simultaneously hydrocarbons are removed safely to a tank, simultaneously preventing environmental spillage into a waterway or into ground and preventing injuries to workers from hazardous gases within the confined space environment.

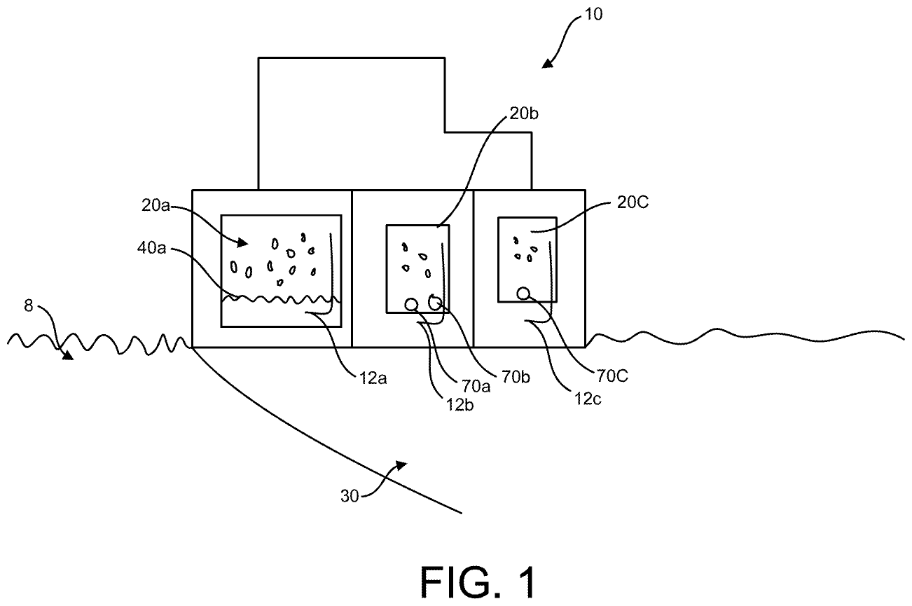

Turning now to the FIGS., FIG. 1 depicts a portion of the safety process for recycling components of a confined space metal container for cleaning and removing hydrocarbons during recycling by reducing sparking, significantly mitigating worker exposure to fire.

In FIG. 1, the confined space metal container 10 is a barge. In other embodiments, the confined space container could be a rail tank car.

Hydrocarbons 12a, 12b, and 12c are depicted within each compartment of the confined space metal container. In FIG. 1 the hydrocarbon can be asphalt. In other embodiments, the hydrocarbon can be high sulfur residual fuel oil bottoms. In yet other embodiments, the hydrocarbons can be vacuum tower bottoms, atmosphere tower bottoms or vacuum gas oil.

FIG. 1 shows the barge 10 with a first compartment 20a positioned on a first containment processing area 30 adjacent a waterway 8, wherein the first containment processing area 30 is configured to prevent environmental spillage from the barge 10.

The containment processing area can be ramp on land, a concrete containment slab for use under railcars, a dry dock with spill contain or an impervious clay area.

The waterway can be a canal, a river, or any access for large marine vessel. In railcar embodiments or truck embodiments, the first containment processing area does not need to be adjacent a waterway.

This FIG. 1 shows a front portion of the barge 10 removed. In this figure, the portion removed is commonly referred to as the bow. The removed portion reveals a plurality of compartments.

Inside the first compartment 20a is a first safety water blanket 40 positioned over heavy hydrocarbons 12 in the first compartment 20a. The second compartment 20b and the third compartment 20c are depicted.

The first safety water blanket 40 can be made from seawater. In other embodiments, the first safety water blanket 40 can be fresh water, recycled water, brackish water, filtered water, recovered water, or in the case of a railcar used at a petrochemical plant, plant water.

The first safety water blanket should be deep enough in the compartment to cover any hydrocarbons contained in the compartments. For example, on a barge that has a 20 foot×20 foot×14 feet first compartment, the first safety water blanket can be from 1 inch to 5 or 6 feet deep.

A feature of the disclosure is to have a water depth of the blanket needs to be just enough to cover the residual bottom before cutting, to minimize pollution to the water and increase the ability to re-use the water in a second compartment quickly and faster. The first safety water blanket can range in depth from 3 inches to 2 feet in other embodiments.

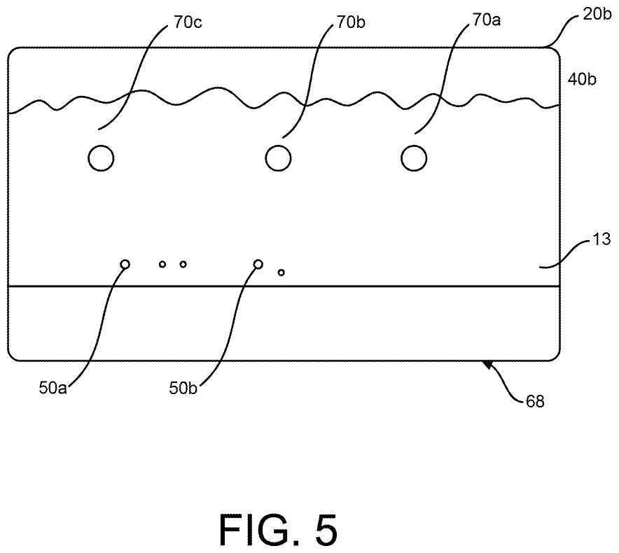

In this FIG. 1, the heavy hydrocarbon with potentially entrained lighter hydrocarbons is not depicted, but FIG. 5 shows a heavy hydrocarbon 13 with potentially entrained lighter hydrocarbon 50. FIG. 5 shows a residual fuel oil bottom that has entrained a percentage (10%) of a distillate 50a, 50b blended in.

The first safety water blanket 40 prevents sparks and explosions when cutting tools are used in the first compartment 20a that present fire in the first compartment.

This first safety water blanket 40 is formed from water from the waterway 8, and is at a temperature equivalent to the waterway, such as from 30 degrees to 97 degrees Fahrenheit.

This first safety water blanket 40 is formed with a thickness ranging from 3 inches to 24 inches.

Continuing with FIG. 1, piping 70a, 70b and 70c are shown. Piping 70a and 70b are in the second compartment 20b and piping 70 c is in the third compartments 20c. The first water blanket 40 is covering up the piping in the first compartment.

In embodiments, piping is above the safety water blanket. In most cases, piping is below the safety water blanket.

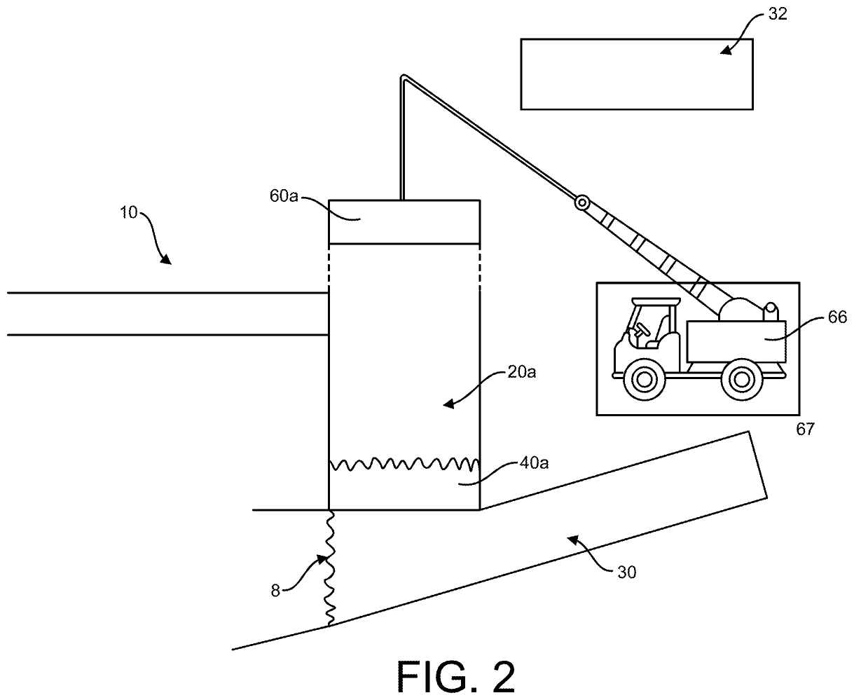

FIG. 2 shows a barge 10 in profile on the first containment area 30, such as a ramp from the intercoastal waterway in Baytown, Tex.

In FIG. 2, the barge 10 is shown with a first top 60a cut and this first top is depicted in the process of being removed from the first compartment 20a having the first water blanket 40.

This barge could be 3 compartment barge.

The first compartment could be 60 feet by 40 feet by 12 feet.

The top can be made from carbon steel.

The top is the same size in width and length as the first compartment.

The first top 60a is depicted removed from the first containment area 30 using a crane 66 sitting at an angle off of the barge. The box around the crane represents a surface area 67 adjacent the first containment area.

This crane 66 moves the first top 60a from the barge 10 to a second containment area 32.

At this second containment area 32 the first top 60a is cut into preset mill sizes while simultaneously mitigating worker exposure to heavy hydrocarbon and heavy hydrocarbon with potentially entrained lighter hydrocarbons in each compartment of the barge. The process mitigates worker exposure to fires in the each compartment.

The crane can be a truck mounted 150 ton boom crane.

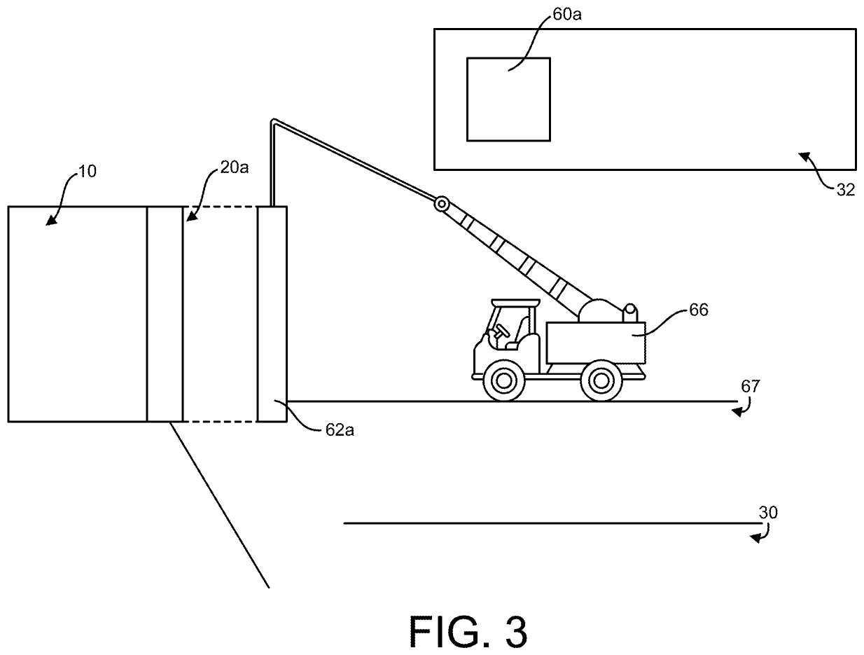

FIG. 3 shows the barge 10 with a first side 62a cut from the first compartment 20a.

The first side 62a is being lifted by the crane 66 in the surface area 67 which is separate from the first containment area 30 to the second containment area 32.

The second containment area already contains the first top 60a. First top 60a is depicted as ready to be cut into preset mill sizes in the second containment area. The first side 62a is then cut into preset mill sizes also in the second containment area 32.

After the cutting is completed on the first compartment, the water of the first safety water blanket 40a can be pumped into the second compartment of the barge 10 forming a second safety water blanket 40b in the second compartment 20b.

Similarly, after cutting on the second compartment 20b is complete, the second safety water blanket 40b can be pumped into the third compartment 20c shown in FIG. 1 forming a third safety water blanket 40c

The process contemplates that after the first safety water blanket is pumped into the second compartment, piping in the first compartment (shown in FIG. 1) is then cut from the first compartment.

The piping is then flushed with the recycle water from the safety water blanket before cutting.

The cutting of the piping is performed using saws, cutting torches, or other mechanical cutting equipment such as a shear.

The cut piping is then lifted from the first containment area, such as with the crane 66 to the second containment area 32, (both containment areas are shown in FIGS. 2 and 3).

The piping is then further cut into preset mill sizes in the second containment area 32.

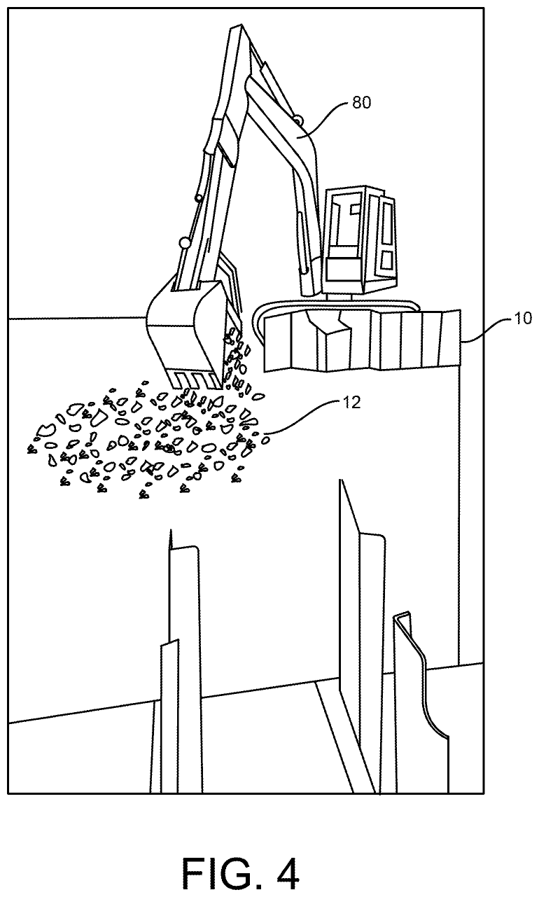

FIG. 4 shows a moveable removable excavator 80 proximate to the barge 10.

In this FIG. 4 the moveable removable excavator is a Hyundai® 210 with bucket.

The moveable removeable excavator 80 is used to remove portions of hydrocarbons 12 from the barge 10 while remaining adjacent the barge or outside the first compartment. The moveable removeable excavator 80 can be used to load the hydrocarbons 12 for transport.

FIG. 5 shows a second compartment 20b.

The second compartment 20b has the first piping 70a, 70b, and 70c.

The second safety water blanket 40b is depicted. a heavy hydrocarbon 13 with potentially entrained lighter hydrocarbons 50a, 50b.

In embodiments of the process, after the top is cut off, the sides are cut off, and the piping is removed, a bottom 68 of each compartment is cut off.

The bottom 68 is then lifted from the first containment area 30 to the second containment area 32 where the bottom is then cut into preset mill sizes.

For multicompartment barges or container, the barge or container is moved so that a second compartment of the metal container or barge is positioned in the first containment processing area to prevent environmental spillage and then repeating the above steps to recycle components of the second compartment, a third compartment and so on.

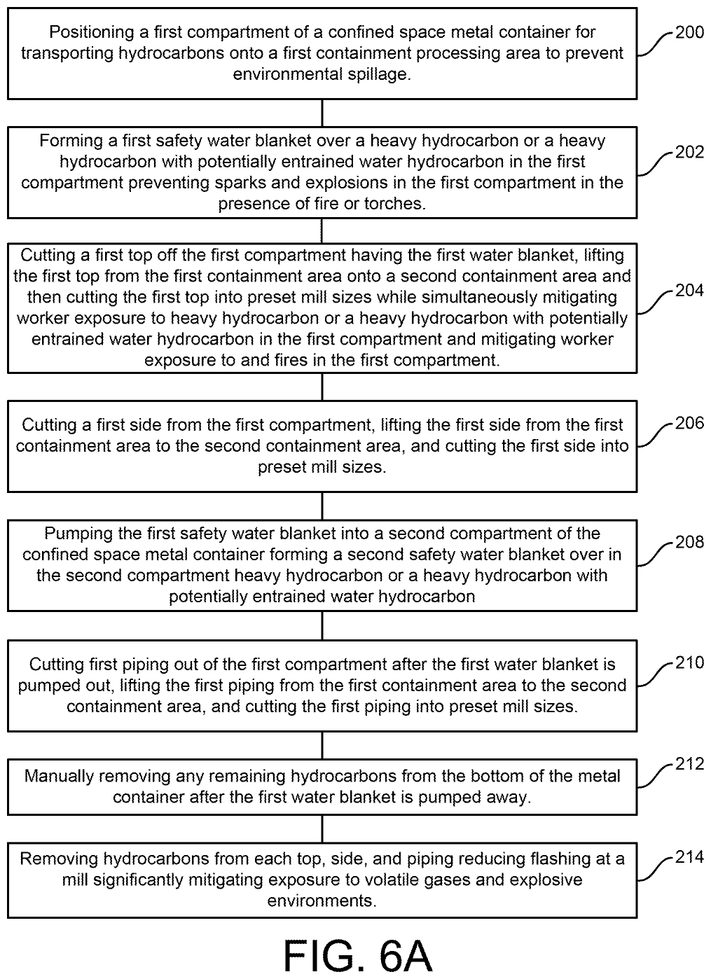

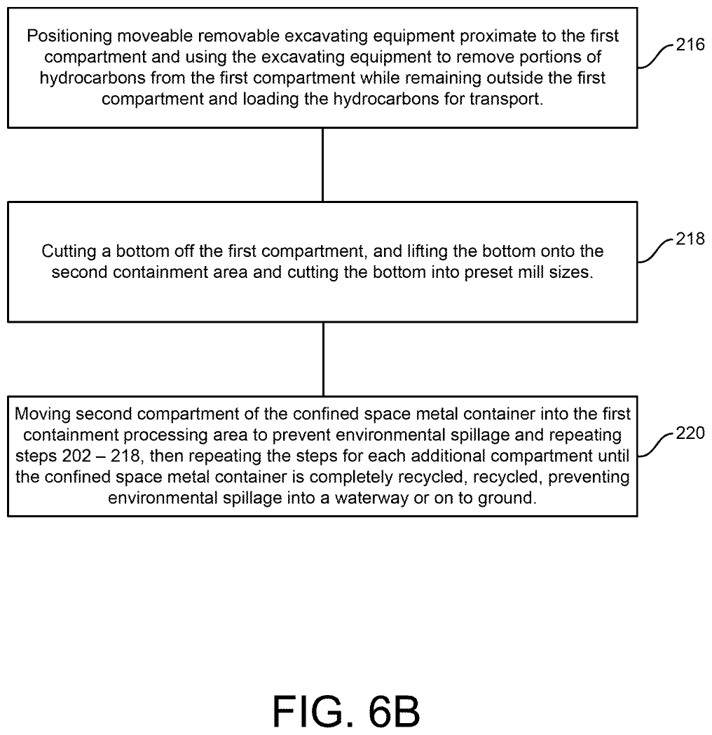

FIGS. 6A-6B depict a diagram of the basic steps of the process.

Step 200 involves positioning a first compartment of a confined space metal container for transporting hydrocarbons onto a first containment processing area to prevent environmental spillage.

Step 202 involves forming a first safety water blanket over a heavy hydrocarbon or a heavy hydrocarbon with potentially entrained lighter hydrocarbons in the first compartment preventing sparks in the first compartment in the presence of fire or torches.

Step 204 involves cutting a first top off the first compartment having the first water blanket, lifting the first top from the first containment area onto a second containment area and then cutting the first top into preset mill sizes while simultaneously mitigating worker exposure to heavy hydrocarbon and (ii) a heavy hydrocarbon with potentially entrained lighter hydrocarbons in the first compartment and mitigating worker exposure to fires in the first compartment.

Step 206 involves cutting a first side from the first compartment, lifting the first side from the first containment area to the second containment area, and cutting the first side into preset mill sizes.

Step 208 involves pumping the first safety water blanket into a second compartment of the confined space metal container forming a second safety water blanket over a heavy hydrocarbon and a heavy hydrocarbon with potentially entrained lighter hydrocarbons in the second compartment.

Step 210 involves cutting first piping out of the first compartment after the first water blanket is pumped out, lifting the first piping from the first containment area to the second containment area, and cutting the first piping into preset mill sizes.

Step 212 involves removing any remaining hydrocarbons from the metal container after the first water blanket is pumped away.

Step 216 involves positioning moveable removeable excavating equipment proximate to the first compartment and using the excavating equipment to remove portions of hydrocarbons from the first compartment while remaining outside the first compartment and loading the hydrocarbons for transport.

Step 218 involves cutting a bottom off the first compartment, and lifting the bottom onto the second containment area and cutting the bottom into preset mill sizes.

Step 220 involves moving a second compartment of the confined space metal container into the first containment processing area to prevent environmental spillage and repeating steps 202-218, then repeating the steps for each additional compartment until the confined space metal container is completely recycled, preventing environmental spillage into a waterway or onto ground.

While these embodiments have been described with emphasis on the embodiments, it should be understood that within the scope of the appended claims, the embodiments might be practiced other than as specifically described herein.

What is claimed is:

1. A safety process for recycling components of a confined space metal container for cleaning and removing hydrocarbons during recycling by reducing sparking, significantly mitigating worker exposure to fires, the process comprising:
a. positioning a first compartment of a confined space metal container for transporting (i) a heavy hydrocarbon or (ii) a heavy hydrocarbon with potentially entrained lighter hydrocarbons into a first containment processing area to prevent environmental spillage;
b. forming a first safety water blanket over the heavy hydrocarbons and the heavy hydrocarbons with potentially entrained lighter hydrocarbons of the first compartment of the confined space metal container preventing sparks and explosions in the first compartment in the presence of fire or torches, wherein the first safety water blanket is at a temperature from 30 to 97 degrees Fahrenheit and has a thickness ranging from 3 inches to 24 inches;
c. cutting a first top off the first compartment having the first water blanket, lifting the first top from the first containment area onto a second containment area and then cutting the first top into preset mill sizes while simultaneously mitigating worker exposure to fires in the first compartment;
d. cutting a first side from the first compartment, lifting the first side from the first containment area to the second containment area, and cutting the first side into preset mill sizes;
e. pumping the first safety water blanket into a second compartment of the confined space metal container forming a second safety water blanket over a second heavy hydrocarbon in a second compartment;
f. cutting first piping out of the first compartment after the first water blanket is pumped out, lifting the first piping from the first containment area to the second containment area, and cutting the first piping into preset mill sizes;
g. removing heavy hydrocarbons and heavy hydrocarbons with potentially entrained lighter hydrocarbons from each top, side, and piping reducing flashing at a mill significantly mitigating exposure to a heavy hydrocarbon and heavy hydrocarbon with potentially entrained lighter hydrocarbons;
h. positioning moveable removeable excavating equipment proximate to the first compartment and using the excavating equipment to remove portions of the heavy hydrocarbons and the heavy hydrocarbon with potentially entrained lighter hydrocarbons from the first compartment while remaining outside the first compartment and loading the heavy hydrocarbons and heavy hydrocarbon with potentially entrained lighter hydrocarbons for transport;
i. cutting a bottom off the first compartment, and lifting the bottom onto the second containment area and cutting the bottom into preset mill sizes;
j. if needed, moving a second compartment of the confined space metal container into the first containment processing area to prevent environmental spillage and repeating steps b-i; and
k. if needed, repeating steps a-j for additional compartments until the confined space metal container is completely recycled, preventing environmental spillage into a waterway or into ground.

2. The safety process of claim 1, wherein the confined space metal container comprises: a steel, an iron, and a non-ferrous metal.

3. The safety process of claim 1, wherein the confined space metal container is a barge, a truck, and in-ground tank, or a rail car.

4. The safety process of claim 1, wherein the safety water blanket is formed sequentially in compartments, one at a time.

6. The safety process of claim 1, wherein the heavy hydrocarbons and heavy hydrocarbon with potentially entrained lighter hydrocarbons are a hard bottom, a sludge, a slurry, or a liquid.

7. The safety process of claim 1, wherein the cutting of the confined space metal container is performed with at least one of: a torch, a mechanical saw, a metal shears, a plasma cutter or a laser.

8. The safety process of claim 1, wherein the heavy hydrocarbons and heavy hydrocarbon with potentially entrained lighter hydrocarbons are from each top, side, and piping are removed by shaking, pressure washing, scraping, or chemical treating.

9. The safety process of claim 1, comprising the step of: inserting a front-end loader into the metal container in at least one compartment once at least one side is cut for removal of heavy hydrocarbons and heavy hydrocarbon with potentially entrained lighter hydrocarbons.

10. The safety process of claim 1, comprising the step of: manually removing heavy hydrocarbons and heavy hydrocarbon with potentially entrained lighter hydrocarbons from the confined space metal container after automated removed is performed.

11. A method of recycling hydrocarbons contained in a waste transportation vehicle, the method comprising:
positioning the waste transportation vehicle next to a first containment area;
filling a hydrocarbon container containing hydrocarbons with water to form a water blanket to cover the hydrocarbons to prevent fire;
cutting a portion of the hydrocarbon container;
moving the cut portion of the hydrocarbon container to a second containment area;
milling the cut portion into smaller pieces for recycling of hydrocarbon material; and
removing the hydrocarbons from the hydrocarbon container.

12. The method of claim 11, further comprising removing the hydrocarbon from the cut portion of the hydrocarbon container.

13. The method of claim 11, further comprising using excavation equipment to remove the hydrocarbon.

14. The method of claim 11, wherein the waste transportation vehicle is a train carrying steel containers.

15. The method of claim 11, wherein the waste transportation vehicle is a truck.

16. The method of claim 11, wherein cutting a portion of the hydrocarbon container comprises cutting a top, a side, and/or a bottom of the hydrocarbon container.

17. A method of preventing fire hazard during recycling of hydrocarbons, the method comprising:
positioning a first one of a plurality of steel containers, carried on a waste transportation vehicle, next to a first containment area;
filling the first one of the plurality of steel containers with water to cover hydrocarbons inside the first one of the plurality of steel containers to prevent fire during metal cutting;
cutting a top portion of the first one of the plurality of steel containers to access an inside space of the first one of the plurality of steel containers to remove the hydrocarbons inside;
and
removing the hydrocarbons from the first one of the plurality of steel containers.

18. The method of claim 17, further comprising moving a second one of the plurality of steel containers to a same position as the first one of the plurality of steel containers, after hydrocarbons are removed from the first one of the plurality of steel containers, to remove hydrocarbons from the second one of the plurality of steel containers.

19. The method of claim 17, further comprising cutting side portions and bottom portion of the first one of the plurality of steel containers and milling all cut portions to smaller pieces to recycle the first one of the plurality of steel containers.

20. The method of claim 17, wherein the hydrocarbons inside the first one of the plurality of steel containers include heavy hydrocarbons and/or light hydrocarbons.
